(19) United States
(12) Patent Application Publication
(10) Pub. No.: US 2004/0211115 A1
(43) Pub. Date: Oct. 28, 2004

(54) MODULAR TREE GUARD AND BICYCLE PARK-AND-LOCK STAND

(76) Inventor: James G. Smith, San Francisco, CA (US)

Correspondence Address: STANLEY H. KREMEN, 4 LENAPE LANE, EAST BRUNSWICK, NJ, 08816, US

(21) Appl. No.: 10/249,616

(22) Filed: Apr. 23, 2003

(51) Int. Cl. A01G 13/02

(52) U.S. Cl. 47/32.4

(57) ABSTRACT

The invention is modular unit and the arrangement of several modular units to surround a tree so as to permit and invite several of bicycles to be secured to them. The modular units are arranged so as not to allow sufficient space for placement of a bicycle adjacent to a tree. Another function of an arrangement of several modular units surrounding a tree is to protect the tree from impact with motor vehicles or from open automobile doors. The modules are best utilized to protect urban planted trees, thereby enhancing and preserving urban environments.

### CROSS REFERENCE TO RELATED APPLICATIONS

This is a nonprovisional utility patent application that is also described and claimed as an ornamental design of my invention in a concurrently filed design patent application entitled MODULAR BICYCLE PARK-AND-LOCK STAND AND TREE GUARD.

### BACKGROUND

Field of Invention

This invention is an implementation of a method that is the subject of a non-provisional utility application filed by Barbara Eber-Schmid entitled METHOD OF PROTECTING URBAN PLANTED TREES FROM PARKED BICYCLES AND OTHER VEHICLES, U.S. patent application Ser. No. 10/271,714, filed on Oct. 16, 2002 (hereinafter the Eber-Schmid application). The Eber-Schmid application is currently pending before the United States Patent and Trademark Office (hereinafter USPTO) and awaiting examination. Both this application and the aforesaid Eber-Schmid application, as well as the inventions described therein, are commonly owned by the NYC Street Tree Consortium, Inc. (a.k.a. TREES NEW YORK). Funding for the development of the invention described in this application was provided by TREES NEW YORK.

This invention relates to a modular unit (hereinafter a MODULE), wherein a plurality of said MODULES are permanently mounted in the ground to surround a tree and to protect said tree from damage from parked bicycles and other vehicles. A plurality of said MODULES are used to either partially or completely surround said tree, and a single MODULE would rarely be used for this purpose. Therefore, said plurality of MODULES would usually be fastened together in a manner described herein prior to insertion in the ground. The primary function of the invention described herein would be to protect an urban planted tree from damage to its trunk from bicycles that lean against the tree or from locking devices that attach to the tree. This is accomplished by surrounding the tree with a plurality of MODULES in such a manner as not to leave enough space to attach a bicycle directly to the tree. At the same time, multiple bicycles may be secured directly to said plurality of MODULES surrounding a single tree using state-of-the-art locking devices. Depending upon the number and arrangement of said plurality of MODULES that surround a tree, another function of the invention described herein would be to protect said tree from damage caused by the impact of an open car door with the tree trunk.

Since tree planting on city streets is necessary for protection of the urban environment, this invention insures that the trees, and therefore the environment will remain safe. Furthermore, the availability of secure bicycle parking on city streets further promotes the use of bicycles for transportation in place of automobiles. Encouraging the use of bicycles for transportation is also helpful to the environment as it decreases pollution from air emissions from automobile exhausts.

### BACKGROUND OF INVENTION

It has long been recognized that trees planted on city streets beautify the environment thereby enhancing it. Trees in urban areas also help to reduce air pollution by absorbing carbon dioxide and producing oxygen during the photosynthesis process. In most urban areas, trees are evident, not only in parks but also in sidewalk tree beds on many streets. Often these tree beds are placed next to the curb and close to vehicular traffic. In many countries where the price of gasoline and the cost of automobiles may be prohibitive to their citizens, bicycles are a principle mode of transportation. By contrast, throughout the United States, people travel primarily in automobiles. The public has received many warnings regarding the deleterious effect of automobile emissions on the environment. Yet, local governments continue to make provisions for the use of increasing numbers of automobiles. Much attention is also paid to promoting the use of public transportation. However, very little attention is paid to bicycle traffic, and consequently, bicycles are rarely used for transportation in urban areas. Many cities throughout the United States have installed bicycle-only lanes in traffic areas adjacent to curbs. At one time, New York City installed such lanes and then removed them because they were under-utilized. Very few cities provide secure park-and-lock facilities for bicycles. Therefore, in the United States, there is an implied discouragement of the use of bicycles for transportation.

Nonetheless, bicycles enjoy some use both for recreation and for primary transportation. Bicycle owners need to securely park their bicycles when not in use to prevent theft. Therefore, it is not uncommon to see bicycles chained or otherwise secured to lamp posts, sign posts, bus stops, parking meters, metal railings, and the trunks of trees planted on city streets. Unfortunately, the metal from bicycles and their locking devices (e.g., chains) cause damage to tree trunks that are more fragile than they appear. Many trees ultimately die from such abuse.

Automobiles also cause damage to urban planted trees. The most common damage is due to the impact of car doors on tree trunks when people exit from parked cars. On city streets, trees are most often planted adjacent to curbs. This is done to maximize pedestrian usage of sidewalks. Trees planted adjacent to traffic areas are very vulnerable to vehicular impact from opening doors or from other parts of the vehicle.

Since the late nineteenth century, tree guards have been used to protect tree trunks from damage. These usually take the form of wrought iron grillwork that surround the tree trunks. They are normally permanently mounted around the tree while the tree is still a sapling since a tree is most vulnerable when it is young. As time passes, the diameter of a tree increases until the metal from the tree guard itself can damage and ultimately strangle the tree. In any event, there is often very little space between the metal from the tree guard and the trunk of a mature tree. Trees surrounded by tree guards do not make very good places to park bicycles.

To protect urban areas from damage by bicycles and other vehicles, planners often plant trees inside soil beds surrounded by brick or cement walls. Clearly, one cannot park and lock a bicycle at such a location. Sometimes a small wrought iron fence would protrude from the stone structure surrounding the tree bed, and such an extension could facilitate bicycle parking. However, such structures are often expensive and unsightly.

The Eber-Schmid application describes a method to both protect urban planted trees from parked bicycles and, at the same time, to provide the location of said trees as a welcoming site for bicycle parking. Her method utilizes a plurality of modular bicycle racks or bicycle locking stands to surround a tree in such a manner as to prevent a bicycle from having access to the tree. The modular bicycle locking stands are firmly anchored to the ground surrounding the tree sufficiently far away as not to cause damage themselves to any element of the tree such as the tree trunk or roots. Said plurality of modular bicycle locking stands present to bicycle owners a much larger perimeter than the circumference of a tree trunk and permit a plurality of bicycles to be parked in the vicinity of a single tree.

Modular bicycle park-and-lock stands of varying designs and constructions are in use in cities and towns around the world. A number of countries have granted patents to inventors for such devices. Most of the patents for bicycle racks have been granted in the United States. Of these, most are design patents that protect the ornamental design of the bicycle racks rather than their functionality or construction. A patent application for a specific implementation of and improvement upon the Eber-Schmid application was filed on Oct. 17, 2002 by Manuel Saez (U.S. non-provisional application Ser. No. 10/273,279) entitled, Bicycle Locking Stand That Prevents Damage To Urban Trees. This application is currently pending before the USPTO and awaiting examination. A corresponding design patent application was also filed by Mr. Saez on Oct. 17, 2002 (Des. patent application Ser. No. 29/169,232) entitled, Modular Bicycle Locking Stand. This application has been examined and has been allowed. Both of the Saez applications are also owned by TREES NEW YORK. A companion design patent application for the bicycle rack described herein has been concurrently filed with the USPTO. Said design patent application is also owned by TREES NEW YORK. A search of the prior art, both patent and non-patent, did not reveal any reference or combination of references other than the Eber-Schmid application and the two Saez applications, that teaches the construction of modular bicycle racks or the use thereof for providing, at the location of an urban planted tree, theft resistant parking of bicycles, providing a park-and-lock station for a plurality of bicycles, and, at the same time, providing protection for said tree.

### SUMMARY OF INVENTION

The invention described herein is for a modular unit and for the arrangement of a plurality of said modular units that surround a tree so as to permit and invite a plurality of bicycles to be secured to said units. The plurality of said modular units are arranged so as not to allow sufficient space for placement of a bicycle adjacent to a tree. Another function of an arrangement of a plurality of said modular units surrounding a tree is to protect said tree from impact with motor vehicles or from open automobile doors. The invention described herein is best utilized to protect urban planted trees, thereby enhancing and preserving urban environments.

### BRIEF DESCRIPTION OF DRAWINGS

FIG. 1 is a top plan view of the first embodiment of a MODULE.

FIG. 2 is a left side elevational view of the first embodiment of a MODULE.

FIG. 3 is a front elevational view of the first embodiment of a MODULE.

FIG. 4 is a right side elevational view of the first embodiment of a MODULE.

FIG. 5A is an isometric view of the first embodiment of a MODULE.

FIG. 5B is a top plan elevational view of the first embodiment of a MODULE that shows the viewing direction of an observer that sees FIG. 5A.

FIG. 6 is a top plan view of the second embodiment of a MODULE.

FIG. 7 is a left side elevational view of the second embodiment of a MODULE.

FIG. 8 is a front elevational view of the second embodiment of a MODULE.

FIG. 9 is a right side elevational view of the second embodiment of a MODULE.

FIG. 10 is an isometric view of a STAGE 2 arrangement of MODULES mounted in a tree bed and surrounding a tree.

FIG. 11 shows the attachment of a bicycle to one of the MODULES contained in the STAGE 2 arrangement of FIG. 10.

FIG. 12 is an exploded view showing a first embodiment for the attachment of two MODULES together to produce the STAGE 2 arrangement shown in FIG. 10.

FIG. 13 is an exploded view showing a second embodiment for the attachment of two MODULES together to produce the STAGE 2 arrangement shown in FIG. 10.

FIG. 14 is a cross sectional exploded view of the two LEGS prior to attachment in an arrangement corresponding to the first attachment embodiment of FIG. 12.

FIG. 15 is a cross sectional exploded view of the two LEGS prior to attachment in an arrangement corresponding to the second attachment embodiment of FIG. 13.

FIG. 16 is a cross sectional view of the two LEGS showing a third embodiment of the attachment of two MODULES together to produce the STAGE 2 arrangement shown in FIG. 10.

FIG. 17 is a top plan schematic showing the mounting of the STAGE 2 arrangement shown in FIG. 10 in a tree bed and surrounding a tree. The MODULES shown in this figure are of the first embodiment shown in FIG. 1 through FIG. 4. They are attached according to either the first or second attachment embodiments shown in FIG. 12 through FIG. 15.

FIG. 18 is a top plan schematic showing the mounting of the STAGE 2 arrangement shown in FIG. 10 in a tree bed and surrounding a tree. The MODULES shown in this figure are of the first embodiment shown in FIG. 1 through FIG. 4. They are attached according to the third attachment embodiment shown in FIG. 16.

FIG. 19 is a top plan schematic showing the mounting of the STAGE 2 arrangement shown in FIG. 10 in a tree bed and surrounding a tree. The MODULES shown in this figure are of the second embodiment shown in FIG. 6 through FIG. 9. They are attached according to either the first or second attachment embodiments shown in FIG. 12 through FIG. 15.

FIG. 20 is a cross sectional schematic showing the mounting of the STAGE 2 arrangement shown in FIG. 10 in a tree bed and surrounding a tree.

FIG. 21, FIG. 22, and FIG. 23 are cross sectional schematics derived from FIG. 20 that show the various dimensional parameters the knowledge of which is necessary to implement and enable the STAGE 2 arrangement shown in FIG. 10.

FIG. 24 is the top plan schematic shown in FIG. 19 showing how the tree can be damaged by opening a door of an automobile parked at the curb adjacent to the tree.

FIG. 25 is an isometric view of a STAGE 3 arrangement mounted in a tree bed.

FIG. 26 is an isometric view of a STAGE 4 arrangement mounted in a tree bed.

FIG. 27 is the top plan schematic shown in FIG. 19 showing how the arrangement of a plurality of MODULES can protect a tree from damage caused by opening a door of an automobile parked at the curb adjacent to the tree.

### DETAILED DESCRIPTION OF THE PREFERRED AND ALTERNATE EMBODIMENTS

The construction of a MODULE comprising the invention of the modular tree guard and bicycle park-and-lock stand described herein is entirely of rigid metal. It is firmly anchored to the ground in such a manner as to be virtually immobile and unbreakable. The metal should be rust resistant. The first embodiment of said MODULE is fabricated by securely attaching two separate pipes or rods (hereinafter LEGS) at approximately right angles to each other. One method of attaching the LEGS would be to create a miter or cut at approximately a 45^{O} angle on one end of each LEG to facilitate attachment of said LEGS at approximately right angles. The two LEGS may be attached by welding or any other method so that they may be approximately at right angles to each other thereby forming the MODULE. Another method of attaching the legs would be to attach one end of an elbow joint to each leg. The end of each LEG is inserted into an end of the elbow joint and secured either by screw treads or welds or other state-of-the-art means. Alternatively, the ends of the elbow joint may be inserted into each LEG provided that the material forming said legs is at least partially hollow. Elbow joints are often used by plumbers to connect two pipes at approximately right angles. Further, each LEG of the MODULE is bent to a curved shape on a single plane. Normally, said LEG would be bent into the shape of a circular arc that forms one-quarter of a circle. However, it may also be bent into an elliptical arc that forms one-quarter of an ellipse. Any similar shaped bend is permissible. At the MODULE'S intersection connecting the two LEGS, the planes passing through the centers of both LEGS are approximately perpendicular to each other. The unjoined ends of both LEGS are to be mounted in the ground. It may be desirable for said unjoined ends to be perfectly vertical when mounted in the ground. However, this is not a requirement. The requirement is that once the module is mounted in the ground, the line of intersection of the planes of the two LEGS may not lie on or close to the ground. The intersection of the two LEGS should be positioned high enough off the ground to facilitate attachment of bicycles to the LEGS and not to pose a tripping hazard to pedestrians. The angle that said unjoined ends make with the vertical upon mounting in the ground depends upon design considerations, and it is intended that this invention include an angular range wherein mounting in the ground remains practical.

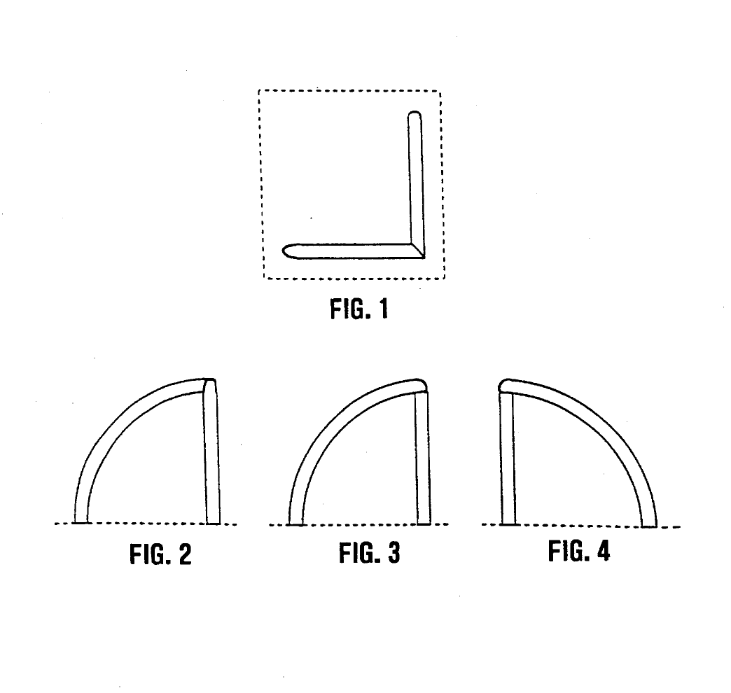

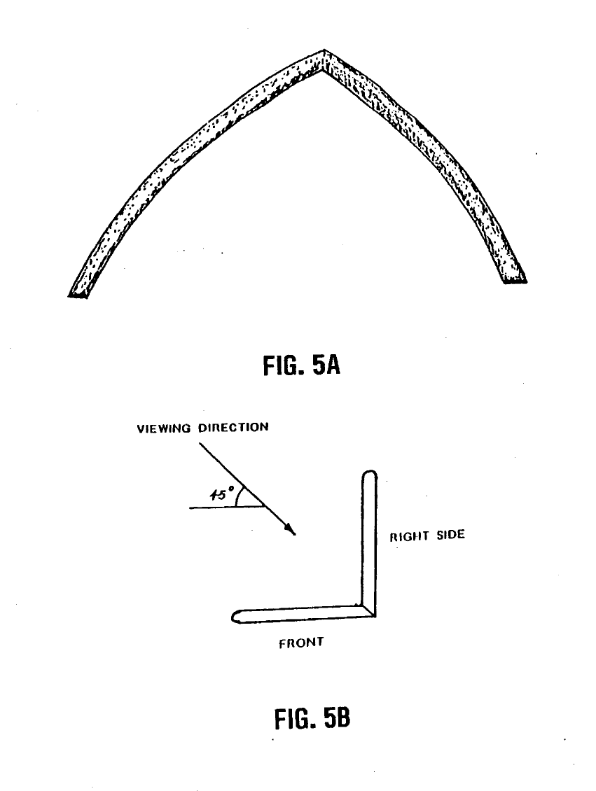

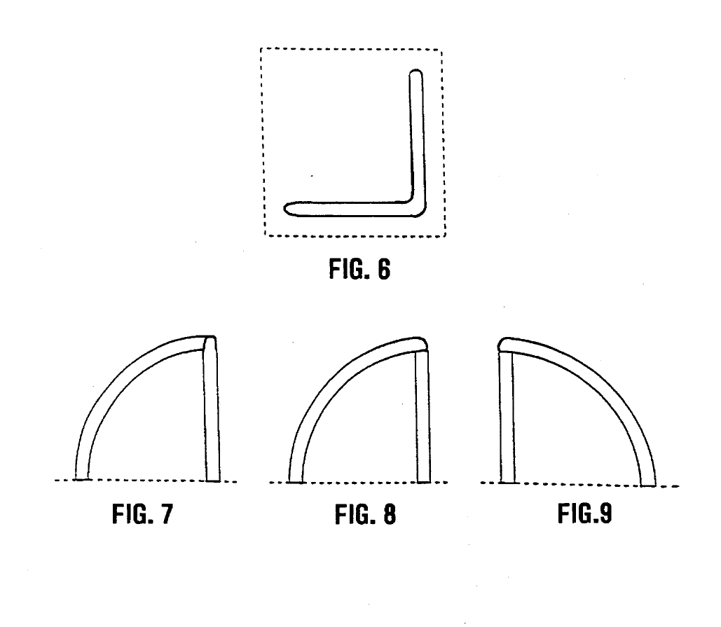

FIG. 1 is a top plan view of the first embodiment of the MODULE. The two LEGS are attached at right angles to each other, and the seam is mitered at an angle of 45^{O} FIG. 2, FIG. 3, and FIG. 4 are left side, front, and right side elevational views of the MODULE, respectively. Only one LEG is visible in each of the elevational views of FIG. 2 through FIG. 4, and the other LEG is obscured. In the figures, each LEG is shown bent into the shape of a quarter circle. FIG. 5A is an isometric view of the MODULE as seen from the rear at an angle of 45^{O} to the two LEGS. FIG. 5B is a top plan view of the MODULE showing the viewing direction necessary to produce the isometric view of FIG. 5A.

The second embodiment of the MODULE is fabricated from a single pipe or rod. In this case, the pipe or rod is bent so as to produce LEGS at approximately right angles to each other. Said LEGS are then further bent so as to produce the curve for each LEG as described in the first embodiment of the MODULE. FIG. 6 is a top plan view of said second embodiment of the MODULE. No seam is present, as the LEGS do not require attachment. FIG. 7, FIG. 8, and FIG. 9 are left-side, front, and right-side elevational views, respectively, and their appearance is identical to FIG. 2, FIG. 3, and FIG. 4, respectively.

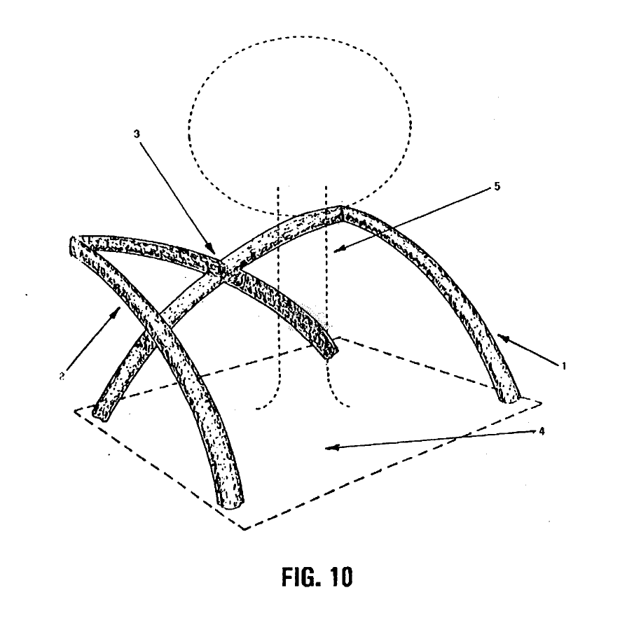

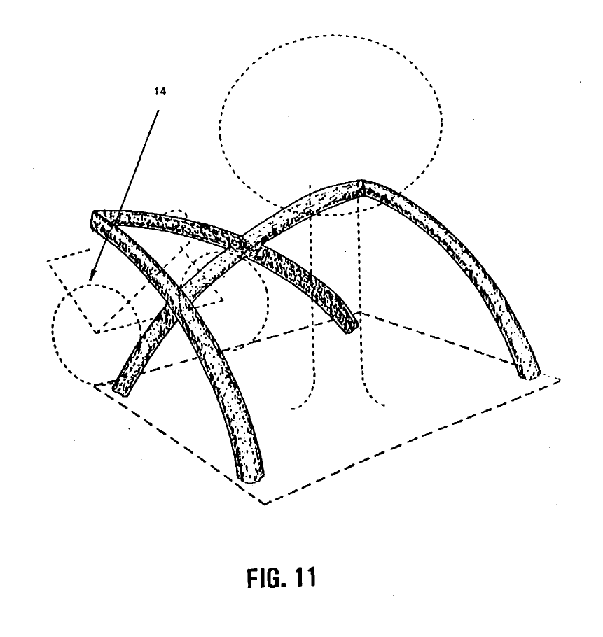

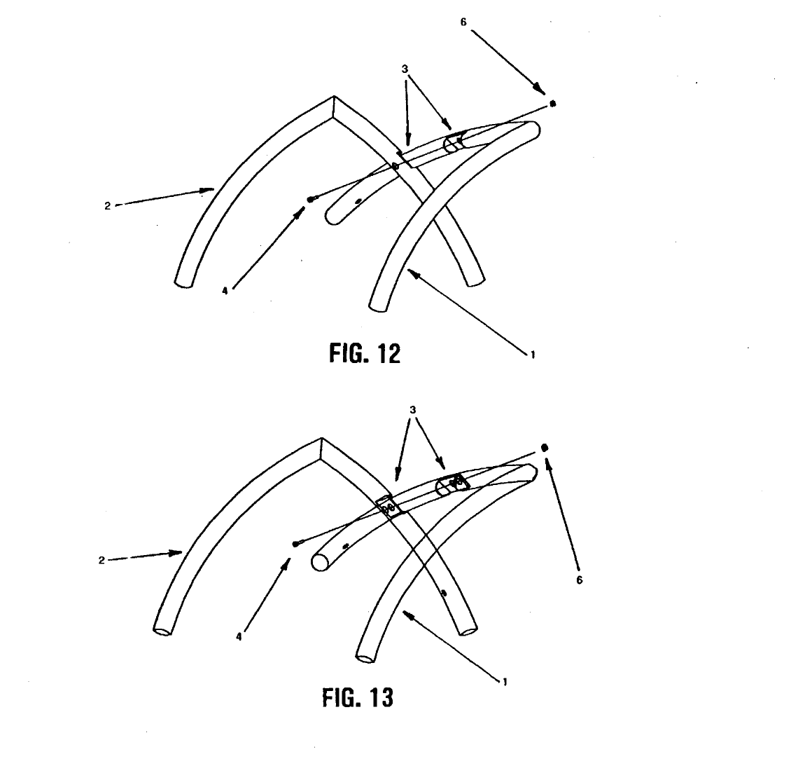

Although a single MODULE may be mounted stand-alone in the ground and used as a bicycle park-and-lock stand, in order to implement its use in a device that protects a tree, a plurality of said MODULES should be used in an arrangement that would surround said tree. In fact, it would be rare for a MODULE to be used in stand-alone mode for this purpose. An exemplary embodiment for this purpose would be an arrangement of two MODULES (hereinafter the STAGE 2 arrangement). This is shown in FIG. 10. In the figure, a first MODULE 1 is securely attached to a second MODULE 2 at joint 3. This STAGE 2 arrangement is securely mounted in tree bed 4, and it partially surrounds tree 5. Tree bed 4 and tree 5 are shown schematically using dashed lines. This STAGE 2 arrangement surrounds said tree on three sides. It is used where the tree is planted in a tree bed on a sidewalk adjacent to a curb. The open end is adjacent to the curb. This STAGE 2 arrangement is used only to protect the tree from parked bicycles and not from motor vehicle traffic on the street. The dimensions of the two MODULES are chosen so as not to provide enough space to lean a bicycle against the tree or to securely lock a bicycle to the tree using a locking device such as a chain. Bicycles may be secured to either MODULE on the sidewalk side of the tree. This arrangement permits several bicycles to be parked in the vicinity of a single tree. FIG. 11 schematically shows a bicycle 14 (using dashed lines) adjacent to the STAGE 2 arrangement on the sidewalk side.

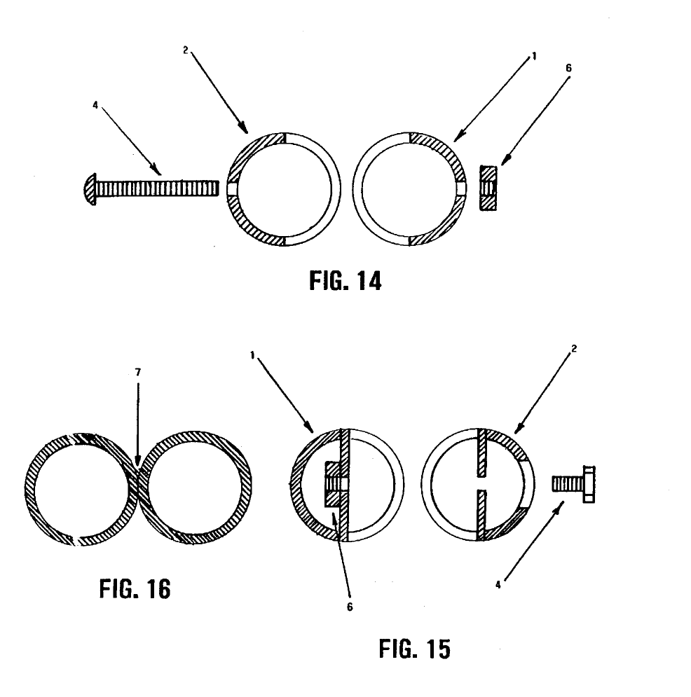

FIG. 12 and FIG. 13 are exploded views showing two attachment embodiments of the STAGE 2 arrangement. In both cases a half-lap joint is used. A half-lap joint is formed between two crossing cylindrical objects at the point of crossing when a section approximately equal to half of the cylindrical diameter is removed from each cylindrical object. When the cut-out sections of the crossing cylindrical objects are place in contact with one another, the two crossing cylinders appear to pass through each other. The half-lap joint may be fabricated in several ways. FIG. 12 and FIG. 13 show the use of a threaded bolt and a tamper resistant lock style nut. In FIG. 12, first MODULE 1 is attached to second MODULE 2 at joint 3 by means of bolt 4 and lock nut 6. In this illustration of the first attachment embodiment, the head of bolt 4 protrudes from second MODULE 2 on the under-side of the STAGE 2 arrangement, and the nut 6 protrudes from first MODULE 1 on the top-side of the STAGE 2 arrangement. Of course, the arrangement of bolt and nut may also be reversed whereby the head of bolt 4 would protrude from first MODULE 1 while the nut 6 would protrude from second MODULE 2. FIG. 14 is a cross sectional view of the two LEGS of the MODULE prior to attachment. FIG. 14 further shows how the first attachment embodiment would be implemented.

FIG. 13 is an exploded view illustrating the second attachment embodiment. In FIG. 13, first MODULE 1 is attached to second MODULE 2 at joint 3 by means of bolt 4 and lock nut 6. However, in this attachment embodiment, neither the head of bolt 4 nor the lock nut 6 protrude from the STAGE 2 arrangement. Bolt 4 and lock nut 6 are secured to each other internally. This is further shown in the cross sectional view of FIG. 15. Of course, the half-lap joint attaching the two MODULES may be produced without the use of a bolt and nut by employing welding, soldering, cementing, gluing or some other state-of-the-art attachment technique.

Alternatively, a third attachment embodiment would be to tack weld the LEGS of two MODULES together. This is shown schematically in the cross sectional view of FIG. 16, where the two LEGS are tack welded together on their exterior surfaces where the LEGS cross at point 7.

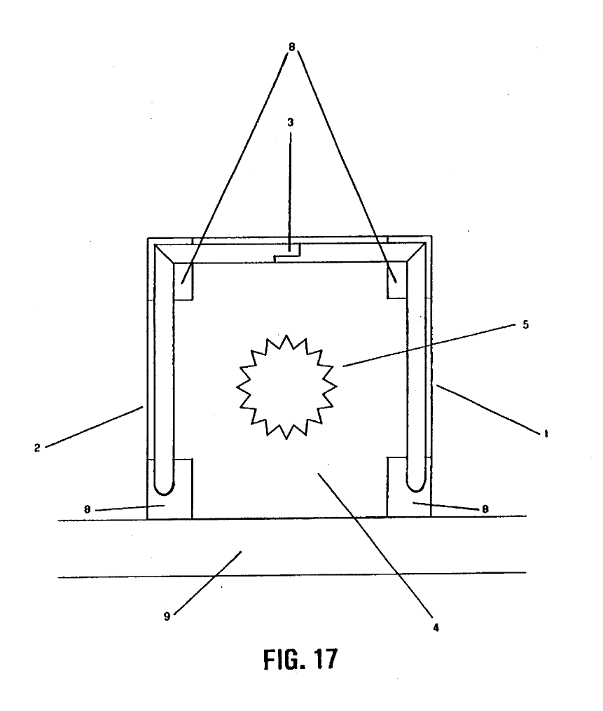

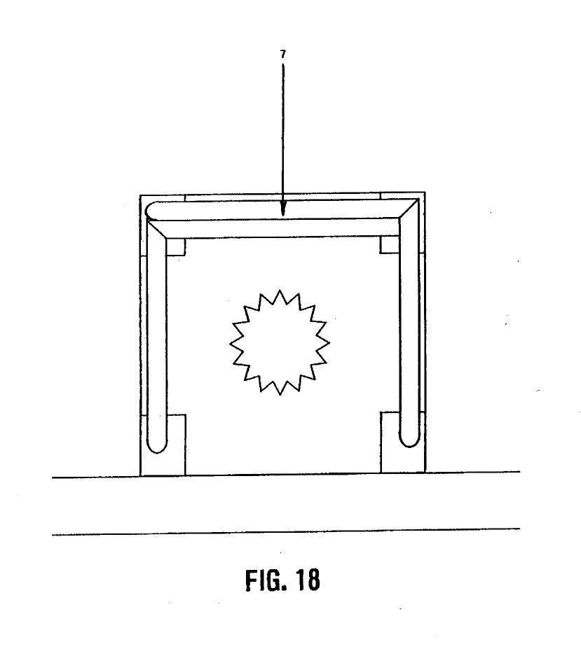

FIG. 17 is a top plan view schematic showing the appearance of the first two attachment embodiments where the STAGE 2 arrangement is mounted in the tree bed. In the figure, first MODULE 1 is attached to second MODULE 2 at lap-joint 3. The entire STAGE 2 arrangement is mounted in four concrete blocks 8 that are buried in the ground in tree bed 4 which is adjacent to curb 9. Tree 5 is planted in the center of tree bed 4, and said tree 5 is surrounded on three sides by the STAGE 2 arrangement. FIG. 18 is a top plan schematic showing the appearance of the third attachment embodiment where the STAGE 2 arrangement is mounted in the tree bed. The two crossing LEGS of the STAGE 2 arrangement are tack welded together at point 7 where the LEGS cross. The second attachment embodiment has a better appearance than the first attachment embodiment since there are no protruding objects (i.e., the bolt head and lock nut). In either of the two attachment embodiments, the LEGS appear to pass through each other. Therefore, the first two attachment embodiments are more attractive than the third attachment embodiment because, in the third attachment embodiment, the LEGS are merely attached to one another on their outside surfaces, and they do not appear to pass through each other. However, the third attachment embodiment (FIG. 16 and FIG. 18) is cheaper to implement than the first attachment embodiment (FIG. 12, FIG. 14, and FIG. 18) which, in turn, is cheaper to implement than the second attachment embodiment (FIG. 13, FIG. 15, and FIG. 18).

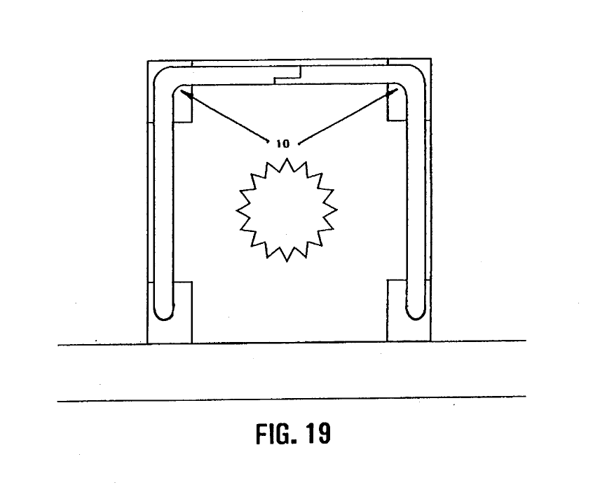

FIG. 19 is a top plan view schematic showing how the STAGE 2 arrangement of the type shown in FIG. 6 through FIG. 9 is mounted in the tree pit. In this embodiment, each of the two MODULES is fabricated by bending a single pipe or rod. Shown in the figure are the two bends 10 on both MODULES.

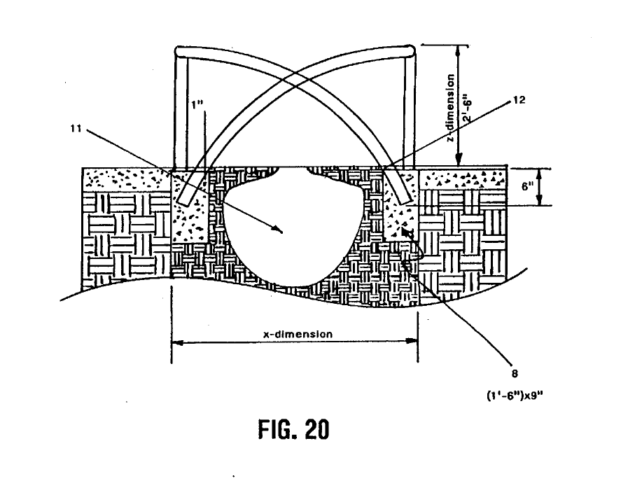

FIG. 20 is a cross sectional view showing how the STAGE 2 arrangement is mounted in the ground of the tree bed. The tree root system, 11, is planted in the center of the tree pit. In the drawing, the LEGS are shown mounted in the concrete blocks, 8, at an angle other than vertical. There are four such concrete blocks as shown in FIG. 17. A typical dimension for a concrete block is one-and-one-half feet by nine inches (1 ft. 6 in.×9 in.). The concrete blocks are buried in the tree pit with their length dimension perpendicular to the ground. The STAGE 2 arrangement is mounted in the concrete blocks while the concrete is still wet. Typically, the LEGS are inserted into the concrete to a depth of six-inches. When the concrete is dry, the STAGE 2 arrangement will be held securely in the ground. There is a drainhole 12 at the top of the footing typically placed eight-inches from the end of the LEG. Normally, the maximum height of the STAGE 2 arrangement will be two-and-one-half feet (2 ft. 6 in.). This provides a reasonable height for locking bicycles to the structure and to avoid a tripping hazard.

In designing a MODULAR arrangement, the following elements must be considered, The most common tree pit dimensions are five feet long by five feet wide by four feet deep. Actual tree pit dimensions vary a great deal. Designs may assume a tree with a three-inch diameter (3 in. caliper) measured 4½ feet above the ground. From ground level up to a height of 18 inches, the structure must not be less than 21 inches from the center of the tree. From a height of 18 inches and up, the structure must not be less then 12 inches from the center of the tree. This is done to account for tree growth. The outermost parts of the structure must be at least 18 inches high so as not to present a tripping hazard. The structure must not extend past the boundary of the tree pit into the sidewalk. For example, for the most common tree pit, the device will be confined to the five foot by five foot footprint of the tree pit.

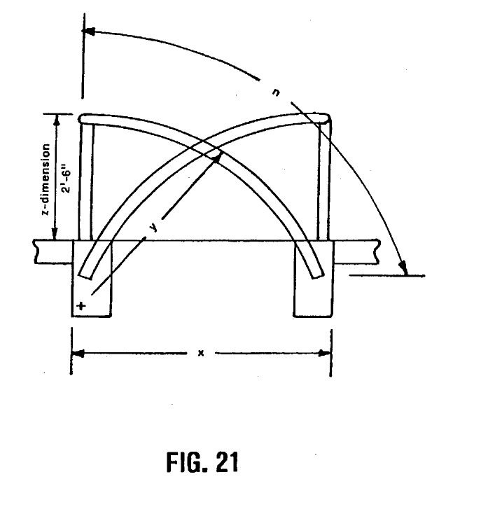

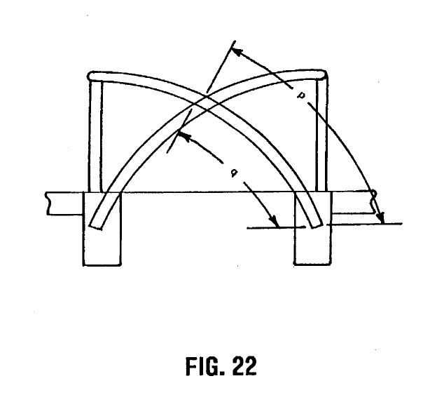

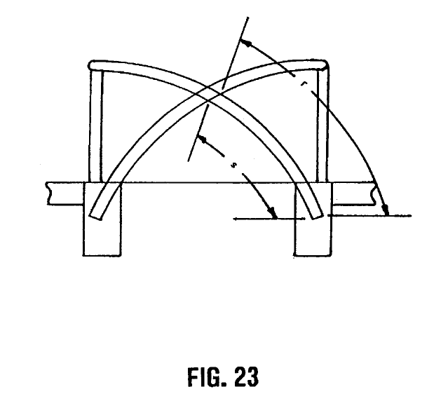

To fabricate the STAGE 2 arrangement, the builder will get the x-dimension of the intended tree pit as is shown in FIG. 20. This is measured inside the concrete edges of the pit. FIG. 21, FIG. 22, and FIG. 23 are cross sectional schematics derived from FIG. 20 that show the various dimensional parameters the knowledge of which is necessary to implement and enable the STAGE 2 arrangement. Assume that all measurements are symmetrical, and assume a LEG that is fabricated from a 2⅞-in. OD pipe or rod. In FIG. 21, x represents the x-dimension of the tree pit (i.e., the distance between the two sidewalls of the tree pit). y represents the radius on topside of the curved LEG. n represents the length of the LEG topside. In FIG. 22, p represents the measurement to the half-lap cut mark on top of the LEG. q represents the measurement to the half-lap cut mark on the bottom of the LEG. In FIG. 23, r represents the measurement to the half-lap cut mark on top of the LEG, and s represents the measurement to the half-lap cut mark on the bottom of the LEG. The builder would use the chart of Table 1 to obtain the outside radius of the tubing to bend for the x-dimension. The chart includes information on where the connection cuts will be made. The information on the chart assumes 2⅞-in. OD pipe or rod. The lower half-lap cut dimensions (r and s) will change if smaller diameter pipe or rod is used.

TABLE 1

| x | y | n | p | q | r | s |
|---|---|---|---|---|---|---|
| 3′ - 6″ | 3′ - 3″ | 5′ - 2¼″ | 3′ - 6 15/16″ | 3′ - 5 9/16″ | 3′ - | 3′ - |
| | | | | | 3½″ | 2¼″ |
| 4′ - 0″ | 3′ - 9″ | 5′ - 5 5/16″ | 3′ - 6⅞″ | 3′ - 5 13/16″ | 3′ - | 3′ - |
| | | | | | 3 7/16″ | 2½″ |
| 4′ - 6″ | 4′ - 5″ | 5′ - 9⅜″ | 3′ - 7 13/16″ | 3′ - 7 5/16″ | 3′ - | 3′ - |
| | | | | | 4 5/16″ | 3 15/16″ |
| 5′ - 0″ | 5′ | 5′ - 0 11/16″ | 3′ - 8 1/16″ | 3′ - 7⅞″ | 3′ - | 3′ - |
| | | | | | 4 9/16″ | 4½″ |
| 5′ - 6″ | 5′ - 10″ | 6′ - 5½″ | 3′ - 9⅞″ | 3′ - | 3′ - | 3′ - |
| | | | | 10 13/16″ | 6¼″ | 6⅝″ |
| 6′ - 0″ | 6′ - 9″ | 6′ - 10½″ | 3′ - 11⅞″ | 4′ - 0⅝″ | 3′ - | 3′ - |
| | | | | | 8 1/16″ | 8⅞″ |
| 6′ - 6″ | 7′ - 8″ | 7′ - 3 3/16″ | 4′ - 1⅝″ | 4′ - 2 11/16″ | 3′ - | 3′ - |
| | | | | | 9 1/16″ | 10 13/16″ |
| 7′ - 0″ | 8′ - 8″ | 7′ - 8⅛″ | 4′ - 3½″ | 4′ - 4 15/16″ | 3′ - | 4′ - |
| | | | | | 11 7/16″ | 0⅞″ |
| 7′ - 6″ | 9′ - 10″ | 8′ - 1½″ | 4′ - 6″ | 4′ - 7¾″ | 4′ - | 4′ - |
| | | | | | 1¾″ | 3 9/16″ |

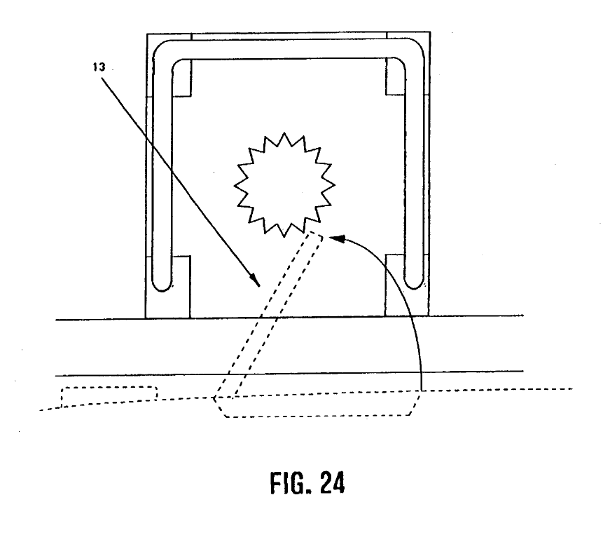

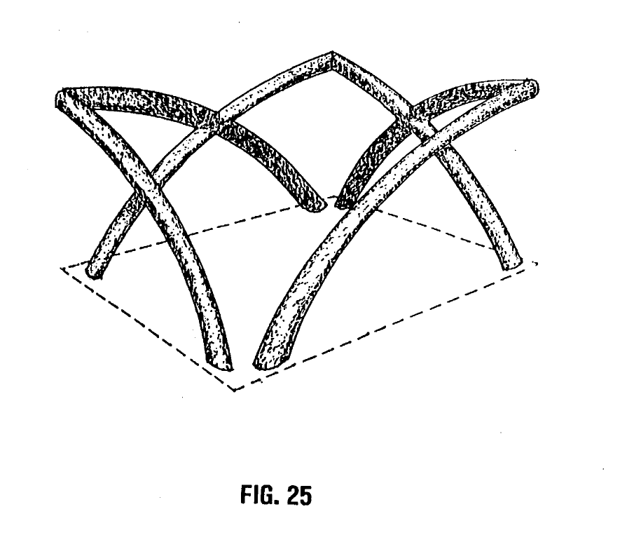

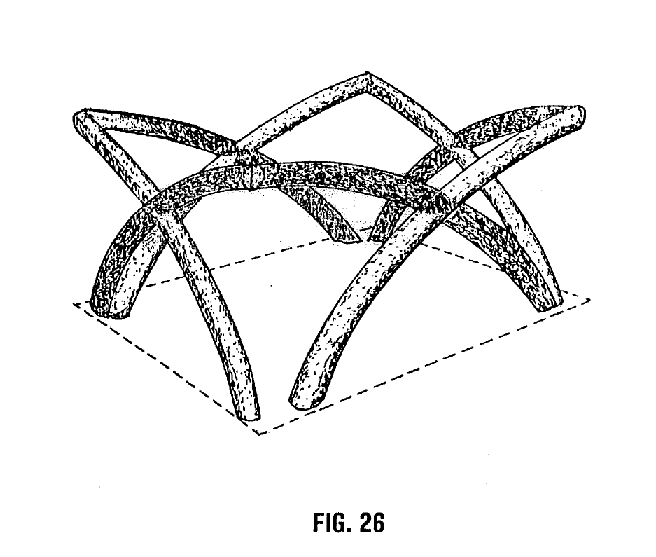

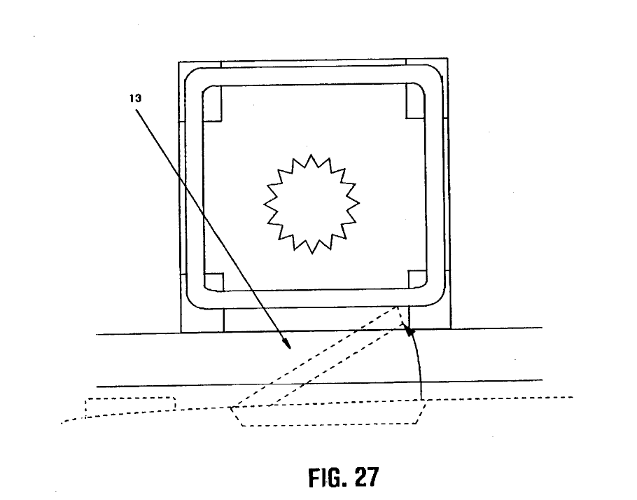

The builder then assembles and installs the STAGE 2 arrangement on-site. Concrete footings are needed at each corner. It is recommended that the top of the footing be 1 to 2 inches below the surface of the sidewalk. The footing is 1½ feet deep allowing 7-9 inches of the pipe or rod to be set in the footing while maintaining the height of the STAGE 2 arrangement at 30 inches. The drain hole must remain clear while the concrete is being poured. Another possible arrangement of two MODULES would be to attach the MODULES at two points where the LEGS cross. Said two-point arrangement should not be confused with the STAGE 2 arrangement that is shown in FIG. 10. In the STAGE 2 arrangement, one LEG from each of the two MODULES is attached to the other at the point where the LEGS cross. The planes passing through the LEGS form a three-sided rectangle. As can be seen in FIG. 10, The LEGS that cross both lie in a single plane. However, if the LEGS are permitted to cross in two separate planes, an arrangement can be created where the two remaining LEGS can also cross. Therefore, the four LEGS of the two MODULES will be attached at two crossing points. The advantage of this arrangement would be that two MODULES would be sufficient to completely surround a tree. While the inventor does not teach away from this embodiment herein, this arrangement has the following disadvantages. First, either this two MODULE arrangement must be mounted in the tree bed so that the footings are mounted much closer to the tree trunk or so that the intersections of the LEGS extend beyond the boundaries of the tree bed. The STAGE 2 arrangement (which is attached at only one point) is mounted with its footings being at the corners of the tree bed while the entire arrangement can be contained entirely within the boundaries of the tree bed. The arrangement of two MODULES attached at two points cannot comply with this design criterion. Therefore, either this two-point arrangement would be mounted dangerously close to the buried tree root ball or the outer boundaries of said arrangement would present a tripping hazard to pedestrians. The second disadvantage of this two-point arrangement would be that if said arrangement is mounted closer to the tree, parked bicycles might not be positioned sufficiently far from the tree trunk to prevent damage to the tree. Therefore, said two-point arrangement of two MODULES is unlikely to be used for the purposes described herein. However, said two-point arrangement of two MODULES could be used as a tree guard in parks or other places where the space required by pedestrians is not as scarce as on city streets. The STAGE 2 arrangement (shown in FIG. 10) is meant to protect urban planted trees from damage caused by bicycles. The advantage of a STAGE 2 arrangement is its relatively low cost. The disadvantage is its inability to protect a tree from damage caused by parked cars. Often, when an occupied vehicle pulls into a parking space parallel to the curb, the driver or one of the passengers opens a car door causing an impact to an unprotected tree trunk. FIG. 24 illustrates this occurrence. FIG. 24 is a top plan schematic view of the typical installation of a STAGE 2 arrangement. The figure shows a three-foot car door, 13, swinging open and hitting the tree trunk. The STAGE 2 arrangement is not meant to protect the curb side of the tree. FIG. 25 shows an assembly of three MODULES, said assembly to be hereinafter referred to as the STAGE 3 arrangement. Here, the MODULES are joined together in two joints as shown in the figure where the LEGS cross. The figure shows the STAGE 3 arrangement schematically mounted in a tree bed. Once again, four concrete blocks are sufficient to provide the footing for mounting the STAGE 3 arrangement. FIG. 26 shows an assembly of four MODULES, said assembly to be hereinafter referred to as the STAGE 4 arrangement. Here, the MODULES are joined together in four joints as shown in the figure where the LEGS cross. The figure shows the STAGE 4 arrangement schematically mounted in a tree bed. Once again, four concrete blocks are sufficient to provide the footing for mounting the STAGE 4 arrangement. The advantage of using the STAGE 3 and STAGE 4 arrangements is that they completely surround the tree. FIG. 27 is a top plan schematic view showing how such an arrangement completely surrounds a tree. In the figure, it can be seen that car door, 13, can no longer cause damage to the tree.

I claim the following:

1. A tree guard and bicycle park-and-lock module consisting essentially of two elements each curved in a single plane and both joined at a single intersection of one end of each curved element,
such that the planes of said two curved elements are neither coincident nor parallel; and,
such that said module has two free ends for mounting in a tree bed.

2. The tree guard and bicycle park-and-lock module of claim 1 mounted in a tree bed such that the intersection of the two curved elements is above the surface of said tree bed.

3. The tree guard and bicycle park-and-lock module of claim 2 mounted in a tree bed such that the line of intersection of the two planes of said curved elements is approximately perpendicular to the ground.

4. The tree guard and bicycle park-and-lock module of claim 1 wherein the curves are formed from pipes or rods.

5. The tree guard module of claim 1 wherein the planes of said two curved elements intersect approximately at right angles.

6. The tree guard and bicycle park-and-lock module of claim 1 produced by joining two separate curved elements together to form said intersection.

7. The tree guard and bicycle park-and-lock module of claim 6 wherein the curved elements are joined in a miter joint to form said intersection.

8. The tree guard and bicycle park-and-lock module of claim 6 wherein the curved elements are welded together to form said intersection.

9. The tree guard and bicycle park-and-lock module of claim 6 wherein the curved elements are joined together using an elbow joint.

10. The tree guard and bicycle park-and-lock module of claim 1 that is produced by bending a single pipe or rod to form the entire module.

11. An arrangement of two tree guard and bicycle park-and-lock modules of claim 2
wherein a point on a curved element of a first module is proximate to a point on a curved element of a second module,
such that said arrangement has four free ends that are mounted in said tree bed.

12. The arrangement of two tree guard and bicycle park-and-lock modules of claim 11 wherein said modules are touching at said proximate points.

13. The arrangement of two tree guard and bicycle park-and-lock modules of claim 11 wherein said modules are fastened together at said proximate points.

14. The arrangement of two tree guard and bicycle park-and-lock modules of claim 13 wherein said modules are fastened together by a half-lap joint.

15. The arrangement of two tree guard and bicycle park-and-lock modules of claim 14 wherein said modules are held together at the half-lap joint by a bolt secured to a locking type nut.

16. The arrangement of two tree guard and bicycle park-and-lock modules of claim 13 wherein said modules are fastened by welding.

17. An arrangement of three tree guard and bicycle park-and-lock modules of claim 2,
wherein a point on a curved element of a first module is proximate to a point on a first curved element of a second module; and,
wherein a point on a curved element of a third module is proximate to a point on a second curved element of a second module;
such that said arrangement has six free ends that are mounted in said tree bed.

18. The arrangement of three tree guard and bicycle park-and-lock modules of claim 17 wherein said modules are touching at said proximate points.

19. The arrangement of three tree guard and bicycle park-and-lock modules of claim 17 wherein said modules are fastened together at said proximate points.

20. The arrangement of three tree guard and bicycle park-and-lock modules of claim 19 wherein said modules are fastened together by half-lap joints.

21. The arrangement of three tree guard and bicycle park-and-lock modules of claim 20 wherein said modules are held together at each said half-lap joint by a bolt secured to a locking type nut.

22. The arrangement of three tree guard and bicycle park-and-lock modules of claim 19 wherein said modules are fastened by welding.

23. An arrangement of four tree guard and bicycle park-and-lock modules of claim 2,
wherein a point on a first curved element of a first module is proximate to a point on a first curved element of a second module; and,
wherein a point on a second curved element of said second module is proximate to a point on a first curved element of a third module; and,
wherein a point on a second curved element of said third module is proximate to a point on a first curved element of a fourth module; and,
wherein a point on a second curved element of said fourth module is proximate to a point on a second curved element of said first module; and,
such that said arrangement has eight free ends that are mounted in said tree bed.

24. The arrangement of three tree guard and bicycle park-and-lock modules of claim 23 wherein said modules are touching at said proximate points.

25. The arrangement of three tree guard and bicycle park-and-lock modules of claim 23 wherein said modules are fastened together at said proximate points.

26. The arrangement of four tree guard and bicycle park-and-lock modules of claim 25 wherein said modules are fastened together by half-lap joints.

27. The arrangement of four tree guard and bicycle park-and-lock modules of claim 26 wherein said modules are held together at each said half-lap joint by a bolt secured to a locking type nut.

28. The arrangement of four tree guard and bicycle park-and-lock modules of claim 25 wherein said modules are fastened by welding.

29. A method of protecting a tree from damage due to bicycles having proximity to said tree by surrounding said tree with a plurality of tree guard and bicycle park-and-lock modules of claim 2.

30. A method of protecting a tree from damage due to bicycles having proximity to said tree by surrounding said tree with the arrangement of two tree guard and bicycle park-and-lock modules of claim 11.

31. A method of protecting a tree from damage due to bicycles or parked automobiles having proximity to said tree by surrounding said tree with the arrangement of three tree guard and bicycle park-and-lock modules of claim 17.

32. A method of protecting a tree from damage due to bicycles or parked automobiles having proximity to said tree by surrounding said tree with the arrangement of four tree guard and bicycle park-and-lock modules of claim 23.

33. A method of securely mounting a tree guard and bicycle park-and-lock module of claim 1 in the ground comprising the steps of:
preparing two holes;
pouring concrete into each hole;
placing each free end of the curved elements of said module into one of said holes; and,
permitting the concrete to dry around said free ends of the curved elements of said module.

34. A method of securely mounting the arrangements of tree guard and bicycle park-and-lock modules of claim 11, 17, or 23 in a tree bed comprising the steps of:
preparing four holes at the four corners of said tree bed;
pouring concrete into each of said four holes;
placing the free ends of the curved elements of said arrangements of tree guard and bicycle park-and-lock modules into the concrete while it is still wet; and,
permitting the concrete to dry around the free ends of the curved elements of said arrangements of tree guard and bicycle park-and-lock modules.

35. The use of the tree guard and bicycle park-and-lock module of claim 1 or the arrangements of tree guard and bicycle park-and-lock modules of claim 11 17, or 23 as a park-and-lock stand for bicycles.

36. The method of producing the tree guard and bicycle park-and-lock module of claim 1 comprising the steps of heating the metal until it is malleable and then bending it into shape.
